(19) United States
(12) Patent Application Publication
(10) Pub. No.: US 2022/0400772 A1
(43) Pub. Date: Dec. 22, 2022

(54) Portable Aerosol Generator

(71) Applicant: EM-TECH Co., Ltd., Gyeongsangnam-do (KR)

(72) Inventors: Young-je Kim, Seoul (KR); Kyeong-seong Park, Gyeongsangnam-do (KR)

(21) Appl. No.: 17/777,181

(22) PCT Filed: Nov. 18, 2020
(86) PCT No.: PCT/KR2020/016227

§ 371 Date: May 16, 2022

(30) Foreign Application Priority Data
Nov. 18, 2019 (KR) 10-2019-0147656

(51) Int. Cl. A24F 40/53; A24F 40/10; A24F 40/42; A24F 40/51; A24F 40/57; A24F 40/46; H05B 1/02

(52) U.S. Cl. CPC A24F 40/53; A24F 40/10; A24F 40/42; A24F 40/51; A24F 40/57; A24F 40/46; H05B 1/0244

(57) ABSTRACT

The present invention relates to a portable aerosol generator that vaporizes a liquid type inhalation material, and more particularly, to a portable aerosol generator that can control the operation by recognizing whether a liquid cartridge or a heater module is genuine and/or whether the liquid cartridge or the heater module is already used. According to the present invention, the portable aerosol generator includes: a main body having a microcontroller and a battery; and a liquid cartridge that is electrically detachably mounted on the main body and that has an identifier, a heating part, and a liquid part for receiving a liquid type inhalation material.

### TECHNICAL FIELD

The present invention relates to a portable aerosol generator that vaporizes a liquid type inhalation material, and more particularly, to a portable aerosol generator that can control the operation by recognizing whether a liquid cartridge or a heater module is genuine and/or whether the liquid cartridge or the heater module is already used.

### BACKGROUND

Aerosols are small liquid or solid particles suspended in the atmosphere that typically have a size of 0.001 to 1.0 μm. In particular, people may inhale aerosols derived from various types of liquids for various purposes. For example, a nebulizer is known for treating diseases.

In general, an electrically-heated aerosol generator includes a battery and an electronic control unit for portability and ease of use and is composed of a cartridge that stores liquid for generating aerosol and an electrically-operated atomizer. An assembly of the cartridge and the atomizer is called ‘cartomizer’. One of the conventional cartomizers is disclosed in Korean registered patent publication 10-1081481. Referring to FIG. 1, the conventional cartomizer includes a liquid tank 1, a heating element 6 disposed in an atomizer part 3 to heat and vaporize a liquid essence transferred through a wick 4, a power terminal 5 electrically connected to the heating element 6, a cotton ball 7 for absorbing an excessive amount of essence introduced through the wick 4, and a mist pipe 2 through which the mist vaporized by the heating element 6 flows. However, the conventional cartomizer does not have a means capable of recognizing whether the cartomizer is genuine or whether the cartomizer is already used, such that the user may use the cartomizer, which is not genuine or which is already used, to possibly cause the overheating or failure of the device.

In addition, referring to FIG. 2, when the user uses an aerosol generator 100, a heater 31 of a liquid cartridge 30 is heated, a liquid is vaporized and introduced into a hole 20 with an aerosol-forming substrate 10 therein through a passage, and a pipe heater 40 is heated that is provided in the hole 20 to heat the aerosol-forming substrate 10 around it, such that the user can inhale both an inhalation material vaporized from the liquid in the liquid cartridge 30 and an inhalation material vaporized from the aerosol-forming substrate 10 in the hole 20. The liquid cartridge 30 can be fit into or detached from the aerosol generator 100. Therefore, the used liquid cartridge 30 can be detached from the aerosol generator 100. However, the aerosol generator 100 does not have a means capable of recognizing whether the liquid cartridge 30 is genuine or whether the liquid cartridge 30 is already used, such that the user may fit the liquid cartridge 30, which is not genuine or which is already used, into the aerosol generator 100 and use it, to possibly cause the overheating or failure of the device.

### SUMMARY

An object of the present invention is to provide a portable aerosol generator that can control the operation by recognizing whether a liquid cartridge or a heater module is genuine and/or whether the liquid cartridge or the heater module is already used.

According to an aspect of the present invention for achieving the above object, there is provided a portable aerosol generator, comprising: a main body having a microcontroller and a battery; and a liquid cartridge that is electrically detachably mounted on the main body and that has an identifier, a heating part, and a liquid part for receiving a liquid type inhalation material, wherein the microcontroller checks whether the liquid cartridge is genuine and/or a puff number by recognizing the identifier of the liquid cartridge.

According to the present invention, the portable aerosol generator can control the operation by recognizing whether the liquid cartridge or the heater module is genuine and/or whether the liquid cartridge or the heater module is already used, by recognizing the identifier and checking whether the liquid cartridge or the heater module is genuine and/or the puff number, which makes it possible to prevent the user from using the liquid cartridge or the heater module, which is not genuine or which is already used, and thereby causing the failure or overheating of the portable aerosol generator.

In addition, according to the present invention, the microcontroller can count the puff number while the portable aerosol generator is used, add the puff number to the puff number stored in the identifier when the use of the portable aerosol generator is finished, and store the resulting puff number in the identifier, which makes it possible to check the liquid cartridge or the heater module, which is not genuine or which is already used, when the puff number exceeds a preset puff number.

### BRIEF DESCRIPTION OF THE DRAWINGS

FIG. 1 is a view for explaining the conventional art.

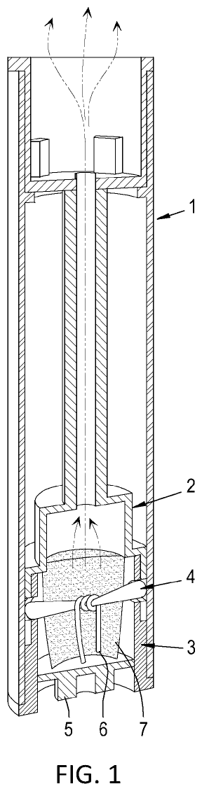

FIG. 2 is a sectional view showing an embodiment of an aerosol generator to which the present invention is applicable.

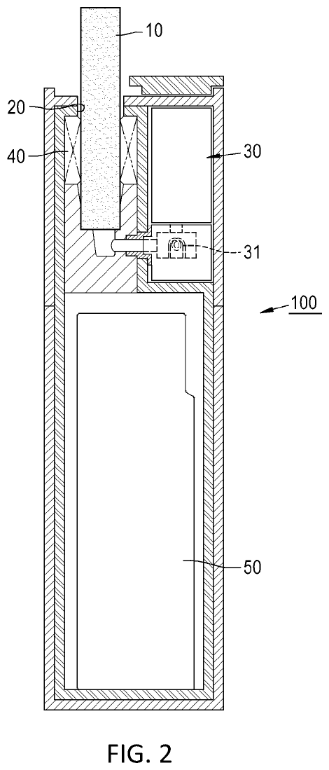

FIG. 3 is a block diagram showing a portable aerosol generator according to one embodiment of the present invention.

FIG. 4 is a block diagram showing a portable aerosol generator according to another embodiment of the present invention.

### DETAILED DESCRIPTION

According to an aspect of the present invention, a portable aerosol generator comprises: a main body having a microcontroller and a battery; and a liquid cartridge that is electrically detachably mounted on the main body and that has an identifier, a heating part, and a liquid part for receiving a liquid type inhalation material.

In some embodiments, the microcontroller may check whether the liquid cartridge is genuine and/or a puff number by recognizing the identifier of the liquid cartridge.

According to another aspect of the present invention, a portable aerosol generator comprises: a main body having a microcontroller and a battery; a heater module that is electrically detachably mounted on the main body and that has an identifier and a heating part; and a liquid cartridge that is detachably mounted on the heater module and that has a liquid part for receiving a liquid type inhalation material, wherein the microcontroller checks whether the heater module is genuine and/or a puff number by recognizing the identifier of the heater module.

In some embodiments, the main body may have a puff sensor, and the microcontroller may count the puff number of the user according to a signal input from the puff sensor while the user uses the portable aerosol generator, add the puff number to the puff number stored in the identifier when the use of the portable aerosol generator is finished, and store the resulting puff number in the identifier.

In some embodiments, the heating part may have a puff sensor, and the microcontroller may count the puff number of the user according to a signal input from the puff sensor while the portable aerosol generator is used, add the puff number to the puff number stored in the identifier when the use of the portable aerosol generator is finished, and store the resulting puff number in the identifier.

In some embodiments, the microcontroller may recognize the identifier, and control the battery to cut off power supplied to the heating part, when the liquid cartridge or the heater module is not genuine.

In some embodiments, the microcontroller may recognize the identifier, and control the battery to cut off power supplied to the heating part, when the puff number exceeds a preset puff number.

Hereinafter, preferred embodiments of a portable aerosol generator according to the present invention will be described in detail with reference to the accompanying drawings.

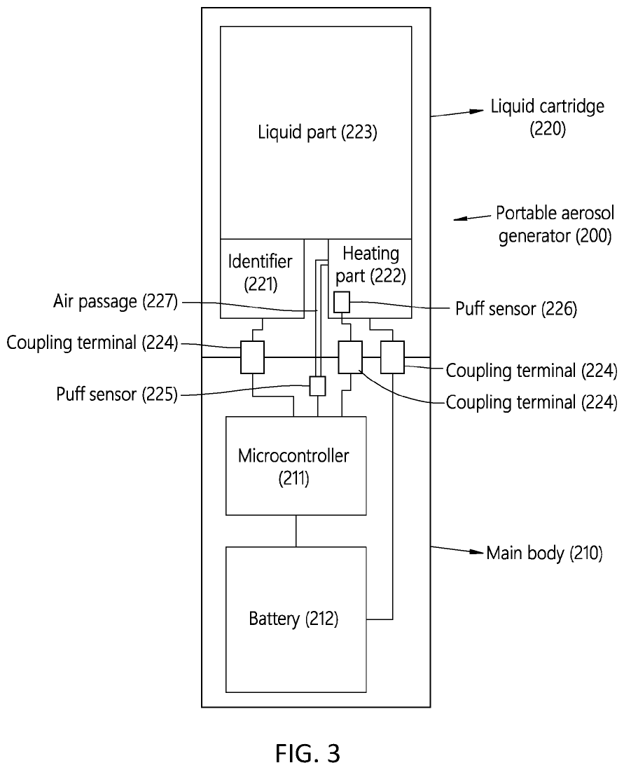

FIG. 3 is a block diagram showing a portable aerosol generator according to one embodiment of the present invention. Referring to FIG. 3, the portable aerosol generator 200 according to one embodiment of the present invention comprises a main body 210 having a microcontroller 211 and a battery 212 and a liquid cartridge 220 that is electrically detachably mounted on the main body 210 and that has an identifier 221, a heating part 222, and a liquid part 223 for receiving a liquid type inhalation material. When the liquid cartridge 220 is fit into the main body 210, the identifier 221 of the liquid cartridge 220 is electrically connected to the microcontroller 211 by a coupling terminal 224, for example. The identifier 221 provided in the liquid cartridge 220 has a memory that stores, e.g., an identifier ID or unique code generation value to make it possible to recognize whether the liquid cartridge 220 is genuine. In addition, a puff number can be stored in the identifier 221 by the microcontroller 211, as discussed later. Further, the heating part 222 provided in the liquid cartridge 220 includes a heater (not shown) that can heat the liquid type inhalation material received in the liquid part 223 by power supplied from the battery 212 provided in the main body 210. When the liquid cartridge 220 is fit into the main body 210, the heating part 222 of the liquid cartridge 220 is electrically connected to the battery 212 by a coupling terminal 224, for example. With the liquid cartridge 220 fit into the main body 210, the microcontroller 211 identifies the identifier 221 of the liquid cartridge 220, reads the identifier ID or unique code generation value stored in the identifier 221, and checks whether the liquid cartridge 220 is genuine. The microcontroller 211 also checks the puff number stored in the identifier 221. In some embodiments, the main body 210 has a puff sensor 225 electrically connected to the microcontroller 211 and connected to the heating part 222 of the liquid cartridge 220 through an air passage 227 when the liquid cartridge 220 is fit into the main body 210. For example, the puff sensor 225 may be a pressure sensor that can sense a pressure change when the user uses the portable aerosol generator 200. The microcontroller 211 counts the puff number of the user according to a signal input from the puff sensor 225 while the user uses the portable aerosol generator 200, with the liquid cartridge 220 fit into the main body 210, adds the puff number to the puff number stored in the identifier 221 when the use of the portable aerosol generator 200 is finished, and stores the resulting puff number in the identifier 221. In some embodiments, the heating part 222 of the liquid cartridge 220 has a puff sensor 226, and the puff sensor 226 is electrically connected to the microcontroller 211 of the main body 210 by a coupling terminal 224 when the liquid cartridge 220 is fit into the main body 210. For example, the puff sensor 226 may be a pressure sensor that can sense a pressure change when the user uses the portable aerosol generator 200. The microcontroller 211 counts the puff number of the user according to a signal input from the puff sensor 226 while the user uses the portable aerosol generator 200, with the liquid cartridge 220 fit into the main body 210, adds the puff number to the puff number stored in the identifier 221 when the use of the portable aerosol generator 200 is finished, and stores the resulting puff number in the identifier 221. In some embodiments, the microcontroller 211 recognizes the identifier 221, and controls the battery 212 to cut off power supplied to the heating part 222, when the liquid cartridge 220 is not genuine. Furthermore, in some embodiments, the microcontroller 211 recognizes the identifier 221, determines the liquid cartridge 220 as the used one when the puff number stored in the identifier 221 exceeds a preset puff number, and controls the battery 212 to cut off power supplied to the heating part 222.

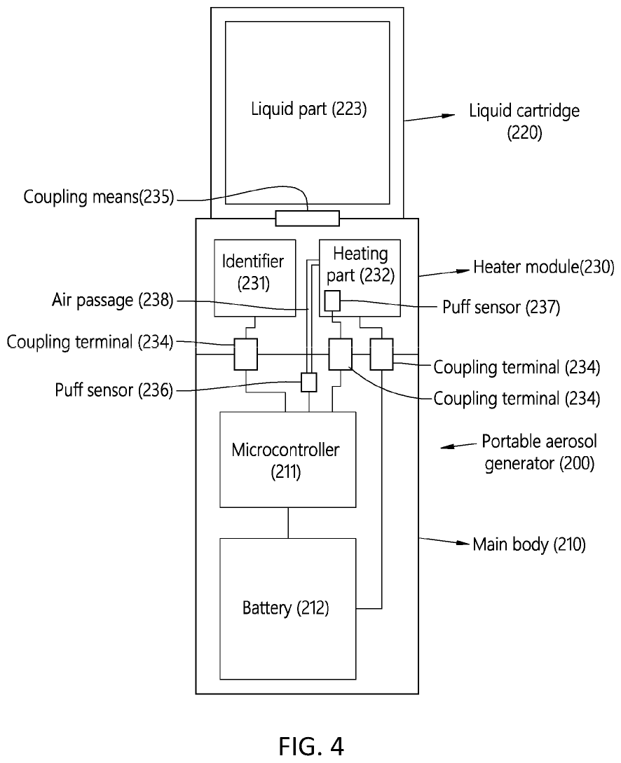

FIG. 4 is a block diagram showing a portable aerosol generator according to another embodiment of the present invention. Referring to FIG. 4, the portable aerosol generator 200 according to another embodiment of the present invention comprises a main body 210 having a microcontroller 211 and a battery 212, a heater module 230 that is electrically detachably mounted on the main body 210 and that has an identifier 231 and a heating part 232, and a liquid cartridge 220 that is detachably mounted on the heater module 230 and that has a liquid part 223 for receiving a liquid type inhalation material. The heater module 230 and the liquid cartridge 220 may be detachably connected by a coupling means 235, for example, such that the user can detach and replace the heater module 230 or the liquid cartridge 220, as desired. For example, with the heater module 230 fit into the main body 210, the user can detach only the liquid cartridge 220 and replace it, or with the liquid cartridge 220 coupled to the heater module 230, the user can detach the heater module 230 from the main body 210, then detach the heater module 230 from the liquid cartridge 220, and replace it. When the heater module 230 is fit into the main body 210, with the liquid cartridge 220 coupled to the heater module 230, the identifier 231 of the heater module 230 is electrically connected to the microcontroller 211 by a coupling terminal 234, for example. The identifier 231 provided in the heater module 230 has a memory that stores, e.g., an identifier ID or unique code generation value to make it possible to recognize whether the heater module 230 is genuine. In addition, a puff number can be stored in the identifier 231 by the microcontroller 211, as discussed later. Further, the heating part 232 provided in the heater module 230 includes a heater (not shown) that can heat the liquid type inhalation material received in the liquid part 233 of the liquid cartridge 220 by power supplied from the battery 212 provided in the main body 210. When the heater module 230 is fit into the main body 210, the heating part 232 of the heater module 230 is electrically connected to the battery 212 by a coupling terminal 234, for example. With the heater module 230 fit into the main body 210, the microcontroller 211 identifies the identifier 231 of the heater module 230, reads the identifier ID or unique code generation value stored in the identifier 231, and checks whether the heater module 230 is genuine. The microcontroller 211 also checks the puff number stored in the identifier 231. In some embodiments, the main body 210 has a puff sensor 236 electrically connected to the microcontroller 211 and connected to the heating part 232 of the heater module 230 through an air passage 238 when the heater module 230 is fit into the main body 210. For example, the puff sensor 236 may be a pressure sensor that can sense a pressure change when the user uses the portable aerosol generator 200. The microcontroller 211 counts the puff number of the user according to a signal input from the puff sensor 236 while the user uses the portable aerosol generator 200, with the heater module 230 fit into the main body 210, adds the puff number to the puff number stored in the identifier 231 when the use of the portable aerosol generator 200 is finished, and stores the resulting puff number in the identifier 231. In some embodiments, the heating part 232 of the heater module 230 has a puff sensor 237, and the puff sensor 237 is electrically connected to the microcontroller 211 of the main body 210 by a coupling terminal 234 when the heater module 230 is fit into the main body 210. For example, the puff sensor 237 may be a pressure sensor that can sense a pressure change when the user uses the portable aerosol generator 200. The microcontroller 211 counts the puff number of the user according to a signal input from the puff sensor 237 while the user uses the portable aerosol generator 200, with the heater module 230 fit into the main body 210, adds the puff number to the puff number stored in the identifier 231 when the use of the portable aerosol generator 200 is finished, and stores the resulting puff number in the identifier 231. In some embodiments, the microcontroller 211 recognizes the identifier 231, and controls the battery 212 to cut off power supplied to the heating part 232, when the heater module 230 is not genuine. Furthermore, in some embodiments, the microcontroller 211 recognizes the identifier 231, determines the heater module 230 as the used one when the puff number stored in the identifier 231 exceeds a preset puff number, and controls the battery 212 to cut off power supplied to the heating part 232.

The present invention is not limited to the preferred embodiment described above. Therefore, it will be understood by one of ordinary skill in the art that various modifications and changes can be made thereto without departing from the spirit and scope of the invention defined by the appended claims.

According to the present invention, the portable aerosol generator can control the operation by recognizing whether the liquid cartridge or the heater module is genuine and/or whether the liquid cartridge or the heater module is already used, which makes it possible to prevent the user from using the liquid cartridge or the heater module, which is not genuine or which is already used, and thereby causing the failure or overheating of the portable aerosol generator.

1-9. (canceled)

10. A portable aerosol generator, comprising:
a main body having a microcontroller and a battery; and
a liquid cartridge that is electrically detachably mounted on the main body and that has an identifier, a heating part, and a liquid part configured to receive a liquid type inhalation material,
wherein the microcontroller is configured to check whether the liquid cartridge is genuine and/or a puff number, by recognizing the identifier of the liquid cartridge.

11. The portable aerosol generator of claim 10, wherein the main body has a puff sensor, wherein the microcontroller is configured to count the puff number of a user according to a signal input from the puff sensor while the user uses the portable aerosol generator, add the puff number to a puff number stored in the identifier when the use of the portable aerosol generator is finished, and store the resulting puff number in the identifier.

12. The portable aerosol generator of claim 11, wherein the microcontroller is configured to recognize the identifier, and control the battery to cut off power supplied to the heating part, when the puff number exceeds a preset puff number.

13. The portable aerosol generator of claim 11, wherein the microcontroller is configured to recognize the identifier, and control the battery to cut off power supplied to the heating part, when the liquid cartridge is not genuine.

14. The portable aerosol generator of claim 10, wherein the heating part has a puff sensor, and wherein the microcontroller is configured to count the puff number of a user according to a signal input from the puff sensor while the user uses the portable aerosol generator, add the puff number to a puff number stored in the identifier when the use of the portable aerosol generator is finished, and store the resulting puff number in the identifier.

15. The portable aerosol generator of claim 14, wherein the microcontroller is configured to recognize the identifier, and control the battery to cut off power supplied to the heating part, when the liquid cartridge is not genuine.

16. The portable aerosol generator of claim 14, wherein the microcontroller is configured to recognize the identifier, and control the battery to cut off power supplied to the heating part, when the puff number exceeds a preset puff number.

17. The portable aerosol generator of claim 10, wherein the microcontroller is configured to recognize the identifier, and control the battery to cut off power supplied to the heating part, when the liquid cartridge is not genuine.

18. A portable aerosol generator, comprising:
a main body having a microcontroller and a battery;
a heater module that is electrically detachably mounted on the main body and that has an identifier and a heating part; and
a liquid cartridge that is detachably mounted on the heater module and that has a liquid part configured to receive a liquid type inhalation material,
wherein the microcontroller is configured to check whether the heater module is genuine and/or a puff number, by recognizing the identifier of the heater module.

19. The portable aerosol generator of claim 18, wherein the main body has a puff sensor, and wherein the microcontroller is configured to count the puff number of a user according to a signal input from the puff sensor while the user uses the portable aerosol generator, add the puff number to a puff number stored in the identifier when the use of the portable aerosol generator is finished, and store the resulting puff number in the identifier.

20. The portable aerosol generator of claim 19, wherein the microcontroller is configured to recognize the identifier, and control the battery to cut off power supplied to the heating part, when the puff number exceeds a preset puff number.

21. The portable aerosol generator of claim 19, wherein the microcontroller is configured to recognize the identifier, and control the battery to cut off power supplied to the heating part, when the liquid cartridge or the heater module is not genuine.

22. The portable aerosol generator of claim 18, wherein the heating part has a puff sensor, and wherein the microcontroller is configured to count the puff number of a user according to a signal input from the puff sensor while the user uses the portable aerosol generator, add the puff number to a puff number stored in the identifier when the use of the portable aerosol generator is finished, and store the resulting puff number in the identifier.

23. The portable aerosol generator of claim 22, wherein the microcontroller is configured to recognize the identifier, and control the battery to cut off power supplied to the heating part, when the liquid cartridge or the heater module is not genuine.

24. The portable aerosol generator of claim 22, wherein the microcontroller is configured to recognize the identifier, and control the battery to cut off power supplied to the heating part, when the puff number exceeds a preset puff number.

25. The portable aerosol generator of claim 18, wherein the microcontroller is configured to recognize the identifier, and control the battery to cut off power supplied to the heating part, when the liquid cartridge or the heater module is not genuine.
